(19) United States
(12) Patent Application Publication
(10) Pub. No.: US 2013/0328887 A1
(43) Pub. Date: Dec. 12, 2013

(54) METHODS AND SYSTEMS FOR HOSTING A PORTION OF A USER INTERFACE AND SYNCHRONIZING ANIMATION BETWEEN PROCESSES

(71) Applicants: Joshua H. Shaffer, San Jose, CA (US); Andrew M. Matuschak, San Francisco, CA (US)

(72) Inventors: Joshua H. Shaffer, San Jose, CA (US); Andrew M. Matuschak, San Francisco, CA (US)

(21) Appl. No.: 13/610,749

(22) Filed: Sep. 11, 2012

Related U.S. Application Data
(60) Provisional application No. 61/657,506, filed on Jun. 8, 2012.

(51) Int. Cl. G06T 13/00

(52) U.S. Cl. 345/473

(57) ABSTRACT

Methods and systems for hosting a portion of a user interface and synchronizing animations between processes are described herein. In one embodiment, a method includes receiving with a first service at least one request for animation from a first process, transferring the at least one request for animation from the first service to a second service associated with a second process, and synchronizing the animation in the multiple views of the multiple processes.

### RELATED APPLICATIONS

This application claims the benefit of Provisional Application No. 61/657,506, filed June 8, 2012, which is incorporated herein by reference.

### FIELD OF THE DISCLOSURE

This disclosure relates to hosting a portion of a user interface and synchronizing animation between processes.

### BACKGROUND OF THE DISCLOSURE

An API is a source code interface that a computer system or program library provides in order to support requests for services from a software application. An API is specified in terms of a programming language that can be interpretative or compiled when an application is built, rather than an explicit low level description of how data is laid out in memory. The software that provides the functionality described by an API is said to be an implementation of the API.

Various devices such as electronic devices, computing systems, portable devices, and handheld devices have software applications. The API interfaces between the software applications and user interface software to provide a user of the device with certain features and operations. A user may desire certain operations such as scrolling, selecting, gesturing, and animating operations for a display of the device. Animating operations include changing content within a given time period. The various types of devices may have a limited display size, user interface, software, API interface and/or processing capability which limit the ease of use of the devices particularly for devices that display two or more software applications.

### SUMMARY OF THE DESCRIPTION

At least certain embodiments of the present disclosure relate to hosting a portion of a user interface and synchronizing animation between processes. A first process may host a portion of a user interface of a second process.

In one embodiment, a method for synchronizing the animations includes receiving with a first service at least one request for animation from a first process, transferring the at least one request for animation from the first service to a second service associated with a second process, and synchronizing the animation in the multiple views of the multiple processes.

Various devices which perform one or more of the foregoing methods and machine readable media which, when executed by a processing system, cause the processing system to perform these methods, are also described.

Other methods, devices and machine readable media are also described.

### BRIEF DESCRIPTION OF THE DRAWINGS

The disclosure is described by way of example with reference to the accompanying drawings, wherein:

FIG. 1 illustrates a method in flow chart form for hosting a portion of a user interface and synchronizing animation between different processes in one embodiment of the present invention;

FIG. 2 (“Software Stack”), in one embodiment of the present invention, illustrates applications that can make calls to services 1 or 2 using several service APIs and to Operating System (OS) using several OS APIs;

FIG. 3 illustrates a diagram for illustrating a cross-process drawing synchronization interface in one embodiment of the present invention;

FIGS. 4 and 5 illustrate synchronizing different software applications for a change in orientation of a display of a device in one embodiment of the present invention;

FIG. 6 illustrates a touch I/O system 3001 that can receive touch input for interacting with computing system 3003 via wired or wireless communication channel 3002 in one embodiment of the present invention;

FIG. 7 shows a wireless system which includes the capability for wireless communication in one embodiment of the present invention; and

FIG. 8 is a block diagram illustrating an exemplary API architecture, which may be used in one embodiment of the present invention.

### DETAILED DESCRIPTION

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

At least certain embodiments of the present disclosure include one or application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. Example application programming interfaces transfer function calls to implement scrolling, gesturing, and animating operations for a device having a display region. An API may also implement functions having parameters, variables, or pointers. An API may receive parameters as disclosed or other combinations of parameters. In addition to the APIs disclosed, other APIs individually or in combination can perform similar functionality as the disclosed APIs.

The display region is a form of a window. A window is a display region which may not have a border and may be the entire display region or area of a display. In some embodiments, a display region may have at least one window and/or at least one view (e.g., web, text, or image content). A window may have at least one view. The methods, systems, and apparatuses disclosed can be implemented with display regions, windows, and/or views.

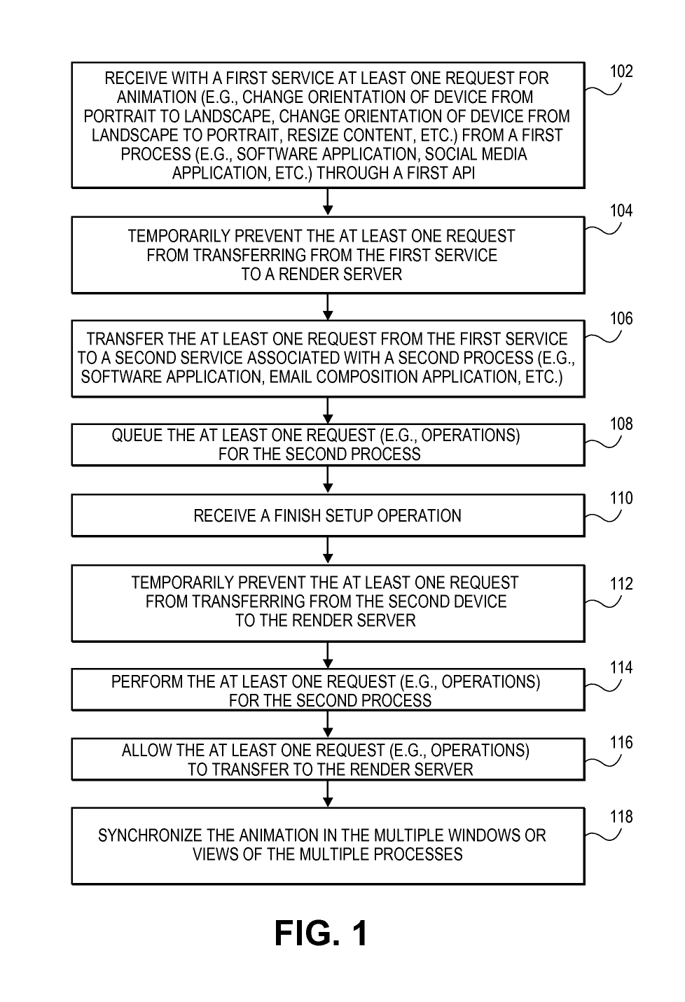

FIG. 1 illustrates a computer-implemented method in flow chart form for hosting a portion of a user interface and synchronizing animation between different processes in one embodiment of the present invention. The computer-implemented method 100 is performed by processing logic that may comprise hardware (circuitry, dedicated logic, etc.), software (such as is run on a general purpose computer system or a dedicated machine or a system), or a combination of both.

User interface software of a device or system interacts with multiple software applications or processes. A portion (e.g., block of software code) of a second application's user interface may be hosted by the first application or vice versa for security and/or performance reasons. The display content for a user interface is managed by a view manager (e.g., view controller or group of view controllers). A Model-View-Controller (MVC) design pattern assigns objects in an application one of three roles: model, view, or controller. The pattern defines not only the roles objects play in the application, it defines the way objects communicate with each other. Each of the three types of objects is separated from the others by abstract boundaries and communicates with objects of the other types across those boundaries. The collection of objects of a certain MVC type in an application is sometimes referred to as a layer—for example, model layer. User actions in the view layer that create or modify data are communicated through a controller object and result in the creation or updating of a model object. When a model object changes (e.g., new data is received over a network connection), it notifies a controller object, which updates the appropriate view objects.

The processing logic receives with a first service at least one request for animation (e.g., change orientation of device from portrait to landscape, change orientation of device from landscape to portrait, resize content, etc.) from a first process (e.g., software application, social media application, etc.) through a first API at block 102. For example, the first process may request view content from the first API, which may include a view manager (e.g., view controller(s)) to manage views associated with the first process. At block 104, the processing logic temporarily prevents the at least one request from transferring from the first service to a render server. A first barrier may be established at block 104 to perform this operation. A barrier can be an operation that executes only when a certain set of operations has executed. In this case, the first barrier prevents the at least one request from transferring from the first service to a render server until the certain set of operations (e.g., operations of blocks 106-114) has executed. At block 106, the processing logic transfers the at least one request from the first service to a second service associated with a second process (e.g., software application, email composition application, etc.). A second API associated with the second service may include a second view manager (e.g., view controller(s)) to manage views associated with the second process. In this manner, a large portion of software code may be moved out of process from the second view manager to the first view manager or vice versa. The first service may include a framework (e.g., public framework that can be accessed by the first application, public framework for email composition) that is associated with the second service (e.g., private interface for email composition). The second service may include a private interface that is associated with the second process.

At block 108, the processing logic queues the at least one request (e.g., operations) for the second process. At block 110, the processing logic receives a finish setup operation. At block 112, the processing logic temporarily prevents the at least one request from transferring from the second service to the render server. A second barrier may be established at block 112 to perform this operation. At block 114, the processing logic performs the at least one request (e.g., operations) for the second process. These operations may include at least one animation (e.g., updating size, changing orientation, changing a display color, hiding a status bar, etc.) and the finish setup operation. At block 116, the processing logic allows the at least one request (e.g., operations) to transfer to the render server based on removal of the first and second barriers. At approximately this time, the first and second processes have committed the animation to the multiple windows or views of the display. At block 118, the processing logic synchronizes the animation in the multiple windows or views of the multiple processes. The multiple processes or software applications (e.g., at least two software applications, at least three software applications) dynamically check in with the render server, which synchronizes the animations for these applications.

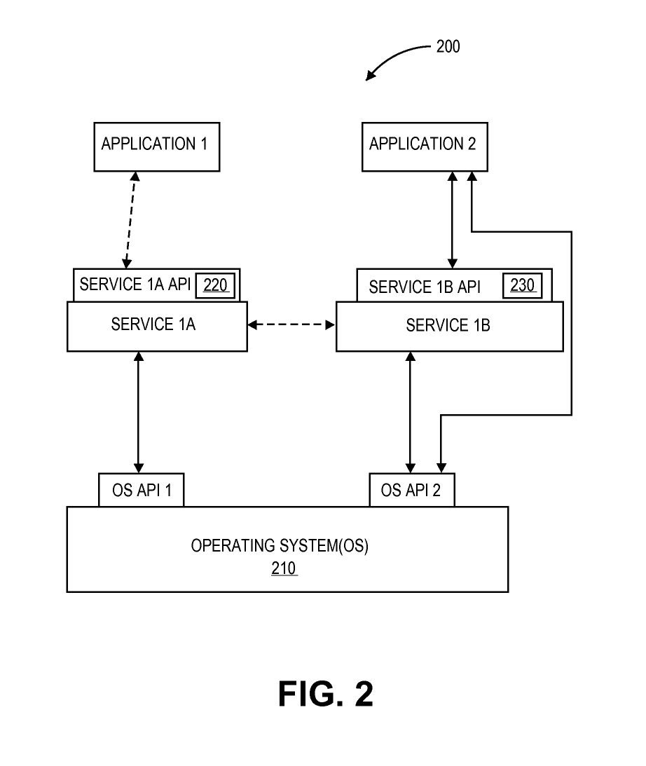

In FIG. 2 (“Software Stack 200”), in one embodiment of the present invention, applications can make calls to services 1A or 1B using several service APIs and to Operating System (OS) 210 using several OS APIs. Services 1A and 1B can make calls to OS using several OS APIs. Note that the service 1B receives calls from and returns values to service 1A. These services may be associated with each other. Service 1B API receives calls from and returns values to application 2. Service 1A, which can be, for example, a software library, makes calls to and receives returned values from OS API 1, and service 1B, which can be, for example, a software library, makes calls to and receives returned values from OS API 2. Application 2 makes calls to and receives returned values from OS API 2. The service 1A API may include a view manager 220 while the service 1B API may include a view manager 230. The application 1 may request the view manager 220 of the service 1A API, but instead receive the view manager 230 of the service 1B API. A large portion of software code may be moved out of process from one view manager to another view manager to vend a view manager from one application for display by another application.

In one embodiment, the application 1 is a social media application or a notes application and the application 2 is an email composition application. Portions of user interfaces for both of these applications (e.g., social media/email applications, notes/email applications) may be displayed at the same time. The views or windows of these user interfaces need to be synchronized in the event of an animation. The software stack 200 provides the ability to synchronize these applications as if the display were controlled by a single application. The service 1A API and the service 1B API, which may be part of the same API or associated with each other, communicate with services 1A and 1B to move portions of software code out of process and synchronize blocks of software code between these services and APIs.

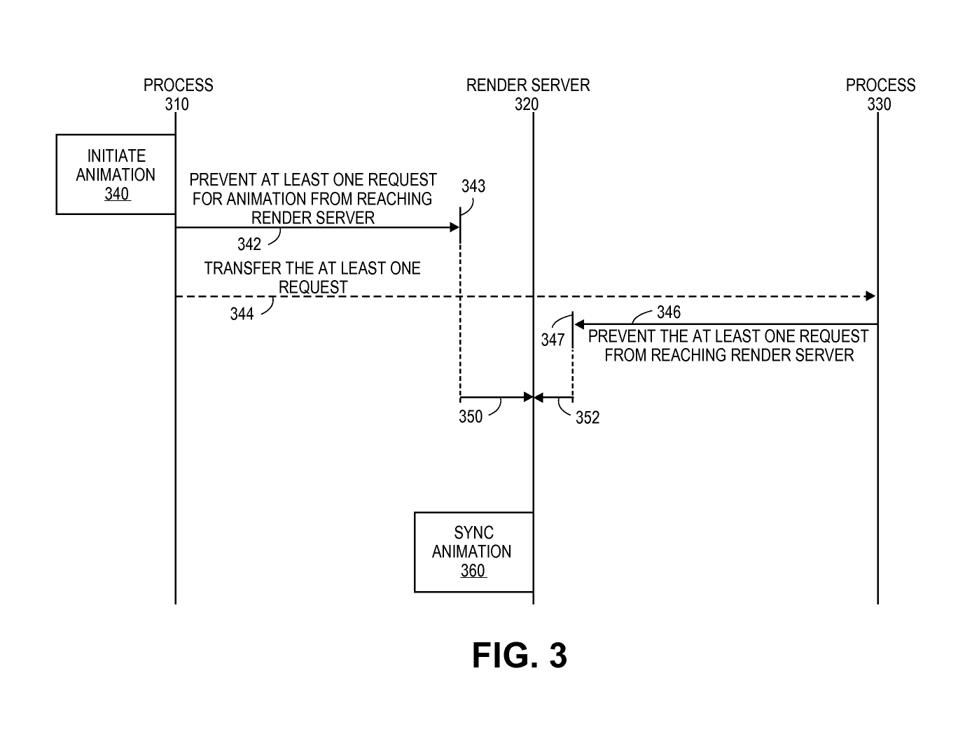

In some embodiments, the software stack 200 provides automated passing of many standard view controller methods (e.g., will rotate to interface orientation, did rotate to interface orientation, etc.), a cross-process drawing synchronization interface as illustrated in FIG. 3, simultaneous touch delivery to both processes, a first responder management across processes, and view controller method forwarding (e.g., appearance, rotation, etc.). The first responder management determines event routing for the two or more applications. For example, a user input may be received from a soft or virtual keyboard located on the display and the first responder management determines which application should receive the user input.

In an embodiment, primitives for drawing synchronization between two or more processes are provided. A primitive can be manipulated and composed. A render server may vend a token that is passed between two or more processes (e.g., A, B, C, D, etc.). Each process using the token can indicate to the render server whether the process has changes or modifications (e.g., changes to an attribute or a property of a view, etc.) that needs to be rendered. For example, an attribute or property of a view may include a position, size, opacity, etc. An animation alters one or more attributes from a first state to a second state. In this manner, an arbitrary number of processes (e.g., applications) can communicate and check in with the render server. When all of the processes are finished with the token, then the render server can perform the rendering in a synchronized manner. In one embodiment, the render server is a software component that implements one or more processes. One process may include receiving commands from applications and these applications describe changes (e.g., draw a red box at a certain location with certain dimensions) that should be made to the graphics displayed on their behalf. Another process (e.g., monitor process) may include coordinating the synchronization of processes holding the token as discussed herein.

FIG. 3 illustrates a diagram for illustrating a cross-process drawing synchronization interface in one embodiment of the present invention. User interface software of a device or system interacts with multiple software applications or processes 310 and 330. A portion (e.g., block of software code) of one application's user interface may be hosted by the other application for security and/or performance reasons. At operation 340, process 310 initiates at least one request for animation (e.g., rotate device, resize content, etc.) with a first service that is associated with the first process. At operation 342, the user interface software temporarily prevents the at least one request (e.g., operations) from transferring to a render server 320. A first barrier 343 may be established to perform this operation. At operation 344, the at least one request is transferred from the first service to a second service associated with a process 330 (e.g., software application, email composition application, etc.). The at least one request is queued until receiving a finish set up operation. At operation 346, upon receiving the finish set up operation, the user interface software temporarily prevents the at least one request from transferring from the second service to the render server. A second barrier 347 may be established to perform this operation. At operation 352, the at least one request is performed for the process 330 and second service. The at least one request may include a queue operation, at least one animation (e.g., updating size, changing orientation, changing a display color, hiding a status bar, etc.), and the finish setup operation. At operations 350 and 352, the user interface software allows the at least one request associated with animation to transfer to the render server based on removal of the first and second barriers. At approximately this time, the processes 310 and 330 have committed the animation to the multiple views of the display. At operation 360, the render server synchronizes the animation in the multiple views of the multiple processes.

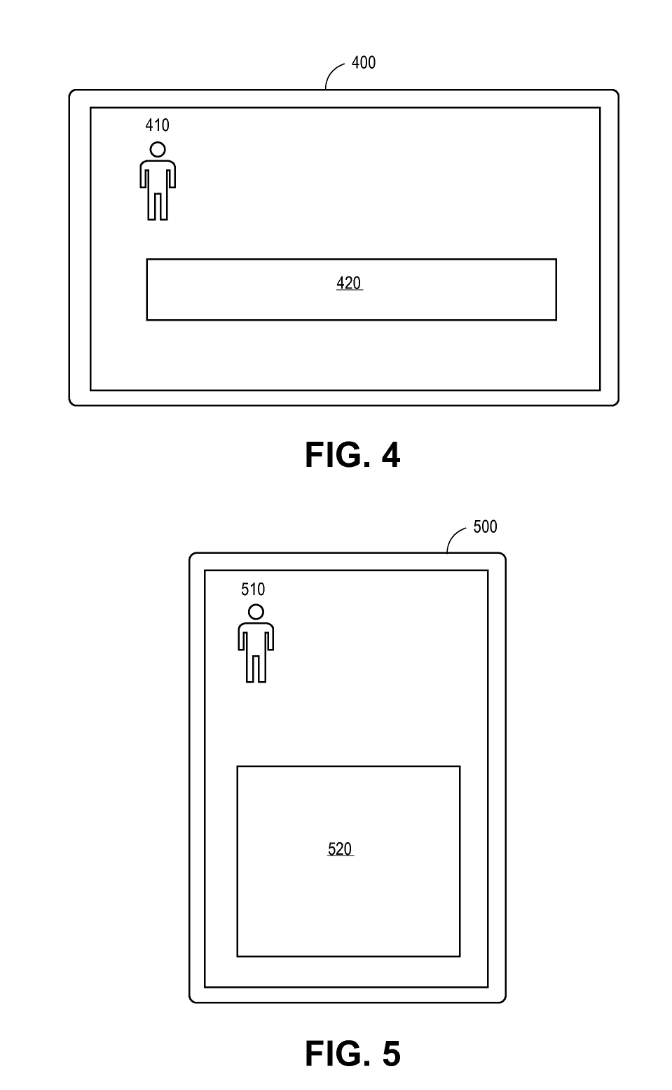

FIGS. 4 and 5 illustrate synchronizing the resizing of views or windows of a display of a device. For example, a window 410 associated with a first process may change from a first state, window 410 of device 400 in FIG. 4, to a second state, window 510 of device 500 in FIG. 5. At approximately the same time, a second window 420 associated with a second process may also change from a first state, window 420, to a second state, window 520. In this example, the change in state is a change in orientation of the device. The method 100 provides synchronization of the change in state of the windows illustrated in FIGS. 4 and 5. The animations in changing from the first state to the second state may occur incrementally and occur with the synchronization of method 100.

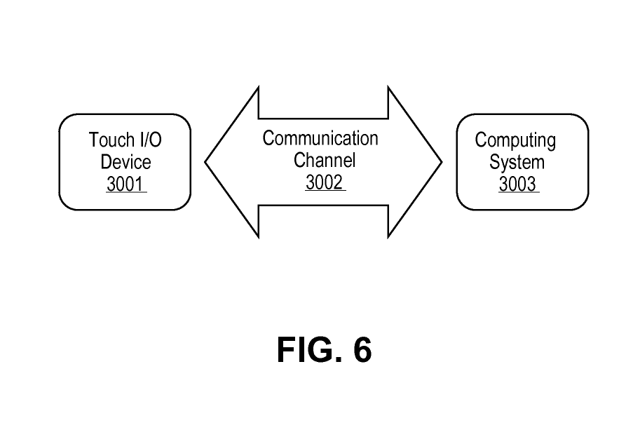

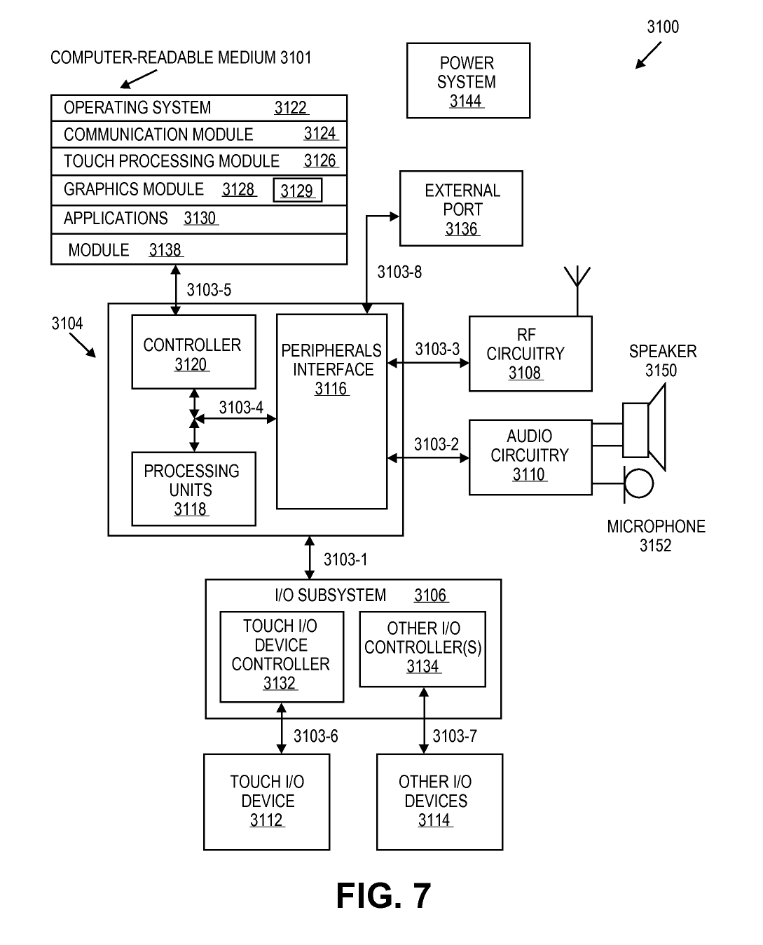

In some embodiments, the methods, systems, and apparatuses of the present disclosure can be implemented in various devices including electronic devices, consumer devices, data processing devices, desktop computers, portable computers, wireless devices, cellular devices, tablet devices, handheld devices, multi touch devices, multi touch data processing devices, any combination of these devices, or other like devices. FIGS. 6 and 7 illustrate examples of a few of these devices.

Described embodiments may include touch I/O device 3001 that can receive touch input for interacting with computing system 3003 as illustrated in FIG. 6 via wired or wireless communication channel 3002 in one embodiment of the present invention. Touch I/O device 3001 may be used to provide user input to computing system 3003 in lieu of or in combination with other input devices such as a keyboard, mouse, etc. One or more touch I/O devices 3001 may be used for providing user input to computing system 3003. Touch I/O device 3001 may be an integral part of computing system 3003 (e.g., touch screen on a laptop) or may be separate from computing system 3003.

Touch I/O device 3001 may include a touch sensitive panel which is wholly or partially transparent, semitransparent, non-transparent, opaque or any combination thereof. Touch I/O device 3001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 3001 embodied as a touch screen may include a transparent and/or semitransparent touch sensitive panel partially or wholly positioned over at least a portion of a display. According to this embodiment, touch I/O device 3001 functions to display graphical data transmitted from computing system 3003 (and/or another source) and also functions to receive user input. In other embodiments, touch I/O device 3001 may be embodied as an integrated touch screen where touch sensitive components/devices are integral with display components/devices. In still other embodiments a touch screen may be used as a supplemental or additional display screen for displaying supplemental or the same graphical data as a primary display and to receive touch input.

Touch I/O device 3001 may be configured to detect the location of one or more touches or near touches on device 3001 based on capacitive, resistive, optical, acoustic, inductive, mechanical, chemical measurements, or any phenomena that can be measured with respect to the occurrences of the one or more touches or near touches in proximity to deice 3001. Software, hardware, firmware or any combination thereof may be used to process the measurements of the detected touches to identify and track one or more gestures. A gesture may correspond to stationary or non-stationary, single or multiple, touches or near touches on touch I/O device 3001. A gesture may be performed by moving one or more fingers or other objects in a particular manner on touch I/O device 3001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 3003 may drive a display with graphical data to display a graphical user interface (GUI). The GUI may be configured to receive touch input via touch I/O device 3001. Embodied as a touch screen, touch I/O device 3001 may display the GUI. Alternatively, the GUI may be displayed on a display separate from touch I/O device 3001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 3001 which may be associated with the graphical elements of the graphical user interface (GUI). In other embodiments, the user may perform gestures at one or more locations that are independent of the locations of graphical elements of the GUI. Gestures performed on touch I/O device 3001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen.

Alternatively, a touch pad generally provides indirect interaction. Gestures may also affect non-displayed GUI elements (e.g., causing user interfaces to appear) or may affect other actions within computing system 3003 (e.g., affect a state or mode of a GUI, application, or operating system). Gestures may or may not be performed on touch I/O device 3001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 3002 in response to or based on the touch or near touches on touch I/O device 3001. Feedback may be transmitted optically, mechanically, electrically, olfactory, acoustically, or the like or any combination thereof and in a variable or non-variable manner.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 3100, including combinations of two or more of these types of devices.

FIG. 7 is a block diagram of one embodiment of the present invention of system 3100 that generally includes one or more computer-readable mediums 3101, processing system 3104, Input/Output (I/O) subsystem 3106, radio frequency (RF) circuitry 3108 and audio circuitry 3110. These components may be coupled by one or more communication buses or signal lines 3103.

It should be apparent that the architecture shown in FIG. 31 is only one example architecture of system 3100, and that system 3100 could have more or fewer components than shown, or a different configuration of components. The various components shown in FIG. 31 can be implemented in hardware, software, firmware or any combination thereof, including one or more signal processing and/or application specific integrated circuits.

RF circuitry 3108 is used to send and receive information over a wireless link or network to one or more other devices and includes well-known circuitry for performing this function. RF circuitry 3108 and audio circuitry 3110 are coupled to processing system 3104 via peripherals interface 3116. Interface 3116 includes various known components for establishing and maintaining communication between peripherals and processing system 3104. Audio circuitry 3110 is coupled to audio speaker 3150 and microphone 3152 and includes known circuitry for processing voice signals received from interface 3116 to enable a user to communicate in real-time with other users. In some embodiments, audio circuitry 3110 includes a headphone jack (not shown).

Peripherals interface 3116 couples the input and output peripherals of the system to processor 3118 and computer-readable medium 3101. One or more processing units 3118 communicate with one or more computer-readable mediums 3101 via controller 3120. Computer-readable medium 3101 can be any device or medium (e.g., storage device, storage medium) that can store code and/or data for use by one or more processing units 3118. Medium 3101 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 3101 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processing units 3118 run various software components stored in medium 3101 to perform various functions for system 3100. In some embodiments, the software components include operating system 3122, communication module (or set of instructions) 3124, touch processing module (or set of instructions) 3126, graphics module (or set of instructions) 3128, one or more applications (or set of instructions) 3130, and hosting/synchronization module [or set of instructions] 3138. In an embodiment, an email composition application is associated with a hosting/synchronization module. Each of these modules, sub-modules, and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments.

In some embodiments, medium 3101 may store a subset of the modules and data structures identified above. Furthermore, medium 3101 may store additional modules and data structures not described above.

Operating system 3122 includes various procedures, sets of instructions, software components and/or drivers for controlling and managing general system tasks (e.g., memory management, storage device control, power management, etc.) and facilitates communication between various hardware and software components.

Communication module 3124 facilitates communication with other devices over one or more external ports 3136 or via RF circuitry 3108 and includes various software components for handling data received from RF circuitry 3108 and/or external port 3136.

Graphics module 3128 includes various known software components for rendering, animating and displaying graphical objects on a display surface. In embodiments in which touch I/O device 3112 is a touch sensitive display (e.g., touch screen), graphics module 3128 includes components for rendering, displaying, and animating objects on the touch sensitive display. The graphics module 3128 includes a render server 3129, which is a software component that implements one or more processes as discussed herein.

One or more applications 3130 can include any applications installed on system 3100, including without limitation, a game center application, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 3126 includes various software components for performing various tasks associated with touch I/O device 3112 including but not limited to receiving and processing touch input received from I/O device 3112 via touch I/O device controller 3132.

System 3100 may further include hosting/synchronization module 3138 for performing the method/functions as described herein. In one embodiment, the hosting/synchronization module 3138 may at least function to provide instructions for receiving with a first service at least one request for animation from a first process, instructions for transferring the at least one request for animation from the first service to a second service associated with a second process, and instructions for synchronizing the animation in multiple views of the multiple processes. The first service may include a framework that is associated with the second process and the second service may include a private interface that is associated with the second process. The hosting/synchronization module 3138 may at least function to provide instructions for temporarily preventing the at least one request from transferring from the first service to a render server, instructions for performing the at least one request for the second process, and instructions for allowing the at least one request to transfer to the render server. The first service may be associated with a first API that includes a view manager to manage views associated with the first process. The second service may be associated with a second API that includes a view manager to manage views associated with the second process.

In another embodiment, a system (e.g., 3003, 3100) includes a computer-readable medium (e.g., 3101) that stores a hosting/synchronization module 3138, one or more processing units (e.g., 3118) that execute a set of instructions associated with the hosting/synchronization module 3138, and an input/output device (e.g., 3001, 3112). The one or more processing units may be configured to receive with a first service at least one request for animation from a first process, to transfer the at least one request for animation from the first service to a second service associated with a second process, and to synchronize the animation in multiple views of the multiple processes.

Module 3138 may also interact with application 3130 to provide the methods and functionality described herein. Module 3138 may be embodied as hardware, software, firmware, or any combination thereof. Although module 3138 is shown to reside within medium 3101, all or portions of module 3138 may be embodied within other components within system 3100 or may be wholly embodied as a separate component within system 3100.

In one embodiment, a data storage medium (e.g., computer-readable medium 3101) containing executable program instructions is executed on a data processing system (e.g., 3003, 3100). The medium includes a software stack that includes an operating system, a first service and associated first view manager, and a second service and associated second view manager. A first application can request the first view manager, but the first application actually receives the second view manager, which is associated with a second application. A portion of software code is moved out of process from the second view manager to the first view manager. The software stack provides the ability to synchronize animation for the first and second applications.

I/O subsystem 3106 is coupled to touch I/O device 3112 and one or more other I/O devices 3114 for controlling or performing various functions. Touch I/O device 3112 communicates with processing system 3104 via touch I/O device controller 2032, which includes various components for processing user touch input (e.g., scanning hardware). One or more other input controllers 2034 receives/sends electrical signals from/to other I/O devices 3114. Other I/O devices 3114 may include physical buttons, dials, slider switches, sticks, keyboards, touch pads, additional display screens, or any combination thereof.

If embodied as a touch screen, touch I/O device 3112 displays visual output to the user in a GUI. The visual output may include text, graphics, video, and any combination thereof. Some or all of the visual output may correspond to user-interface objects. Touch I/O device 3112 forms a touch-sensitive surface that accepts touch input from the user. Touch I/O device 3112 and touch screen controller 3132 (along with any associated modules and/or sets of instructions in medium 3101) detects and tracks touches or near touches (and any movement or release of the touch) on touch I/O device 3112 and converts the detected touch input into interaction with graphical objects, such as one or more user-interface objects. In the case in which device 3112 is embodied as a touch screen, the user can directly interact with graphical objects that are displayed on the touch screen. Alternatively, in the case in which device 3112 is embodied as a touch device other than a touch screen (e.g., a touch pad), the user may indirectly interact with graphical objects that are displayed on a separate display screen embodied as I/O device 3114.

Embodiments in which touch I/O device 3112 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 3112 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 3100 also includes power system 3144 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 3116, one or more processing units 3118, and memory controller 3120 may be implemented on a single chip, such as processing system 3104. In some other embodiments, they may be implemented on separate chips.

In certain embodiments of the present disclosure, the system 3003 or system 3100 or combinations of systems 3003 or 3100 can be used to implement at least some of the methods discussed in the present disclosure.

Some portions of the detailed descriptions are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing or transmitting information in a form readable by a machine (e.g., a computer). For example, machines store and communicate (internally and with other devices over a network) code and data using machine-readable media, such as machine storage media (e.g., magnetic disks; optical disks; random access memory; read only memory; flash memory devices; phase-change memory).

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program (e.g., game center application) to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

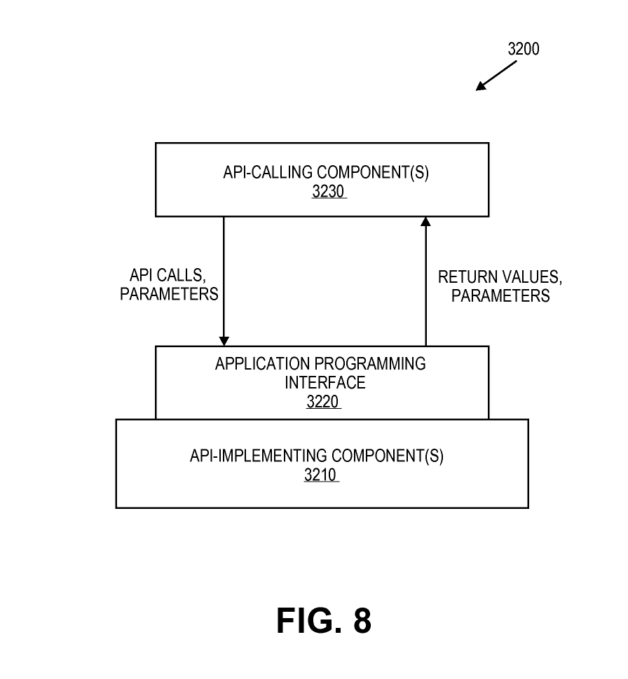

FIG. 8 is a block diagram illustrating an exemplary API architecture, which may be used in one embodiment of the present invention. As shown in FIG. 8, the API architecture 3200 includes the API-implementing component 3210 (e.g., an operating system, a library, a device driver, an API, an application program, software or other module) that implements the API 3220. The API 3220 specifies one or more functions, methods, classes, objects, protocols, data structures, formats and/or other features of the API-implementing component that may be used by the API-calling component 3230. The API 3220 can specify at least one calling convention that specifies how a function in the API-implementing component receives parameters from the API-calling component and how the function returns a result to the API-calling component. The API-calling component 3230 (e.g., an operating system, a library, a device driver, an API, an application program, software or other module) makes API calls through the API 3220 to access and use the features of the API-implementing component 3210 that are specified by the API 3220. The API-implementing component 3210 may return a value through the API 3220 to the API-calling component 3230 in response to an API call.

It will be appreciated that the API-implementing component 3210 may include additional functions, methods, classes, data structures, and/or other features that are not specified through the API 3220 and are not available to the API-calling component 3230. It should be understood that the API-calling component 3230 may be on the same system as the API-implementing component 3210 or may be located remotely and accesses the API-implementing component 3210 using the API 3220 over a network. While FIG. 8 illustrates a single API-calling component 3230 interacting with the API 3220, it should be understood that other API-calling components, which may be written in different languages (or the same language) than the API-calling component 3230, may use the API 3220.

The API-implementing component 3210, the API 3220, and the API-calling component 3230 may be stored in a machine-readable medium (e.g., computer-readable medium), which includes any mechanism for storing information in a form readable by a machine (e.g., a computer or other data processing system). For example, a machine-readable medium includes magnetic disks, optical disks, random access memory; read only memory, flash memory devices, etc.

In the foregoing specification, the disclosure has been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. In an environment with a device having a display with multiple views and user interface software interacts with multiple processes that alter the multiple views, a method, comprising:
receiving with a first service at least one request for animation from a first process;
transferring the at least one request for animation from the first service to a second service associated with a second process; and
synchronizing the animation in the multiple views of the multiple processes.

2. The method of claim 1, wherein the first service includes a framework that is associated with the second process and the second service includes a private interface that is associated with the second process.

3. The method of claim 2, further comprising:
temporarily preventing the at least one request from transferring from the first service to a render server;
queuing the at least one request for the second process;
performing the at least one request for the second process;
allowing the at least one request to transfer to the render server.

4. The method as in claim 1, wherein the first service is associated with a first API that includes a view manager to manage views associated with the first process.

5. The method as in claim 4, wherein the second service is associated with a second API that includes a view manager to manage views associated with the second process.

6. The method as in claim 5, wherein the first process requests the view manager of the first API and receives the view manager of the second API.

7. A computer readable medium storing executable program instructions which when executed cause a data processing system to perform a method comprising:
receiving with a first service at least one request for animation from a first process;
transferring at least one request for animation from the first service to a second service associated with a second process; and
synchronizing the animation in the multiple views of the multiple processes.

8. The computer readable medium of claim 7, wherein the first service includes a framework that is associated with the second process and the second service includes a private interface that is associated with the second process.

9. The computer readable medium of claim 8, the method further comprising:
temporarily preventing the at least one request from transferring from the first service to a render server;
queuing the at least one request for the second process;
performing the at least one request for the second process;
allowing the at least one request to transfer to the render server.

10. The computer readable medium as in claim 7, wherein the first service is associated with a first API that includes a view manager to manage views associated with the first process.

11. The computer readable medium as in claim 10, wherein the second service is associated with a second API that includes a view manager to manage views associated with the second process.

12. The computer readable medium as in claim 11, wherein the first process requests the view manager of the first API and receives the view manager of the second API.

13. A system, comprising:
at least one processing unit coupled to an input panel;
a memory coupled to the least one processing unit; and
one or more programs, wherein the one or more programs are stored in the memory and configured to be executed by the processing unit, the programs including:
instructions for receiving with a first service at least one request for animation from a first process,
instructions for transferring the at least one request for animation from the first service to a second service associated with a second process, and
instructions for synchronizing the animation in multiple views of the multiple processes.

14. The system of claim 13, wherein the first service includes a framework that is associated with the second process and the second service includes a private interface that is associated with the second process.

15. The system of claim 14, the programs further comprising:
instructions for temporarily preventing the at least one request from transferring from the first service to a render server,
instructions for performing the at least one request for the second process, and
instructions for allowing the at least one request to transfer to the render server.

16. The system in claim 13, wherein the first service is associated with a first API that includes a view manager to manage views associated with the first process.

17. The system as in claim 16, wherein the second service is associated with a second API that includes a view manager to manage views associated with the second process.

18. The system as in claim 17, wherein the first process requests the view manager of the first API and receives the view manager of the second API.

19. A data storage medium containing executable program instructions to be executed on a data processing system, the medium comprising:
a software stack comprising,
an operating system,
a first service and associated first view manager, and
a second service and associated second view manager, wherein a first application requests the first view manager and receives the second view manager, which is associated with a second application.

20. The data storage medium of claim 19, wherein a portion of software code is moved out of process from the second view manager to the first view manager.

21. The data storage medium of claim 19, wherein the software stack provides the ability to synchronize animation for the first and second applications.

22. The data storage medium of claim 19, wherein a dynamic arbitrary number of applications including the first and second applications and one or more additional applications communicate with a render server that synchronizes animations for the dynamic arbitrary number of applications.
